(19) United States
(12) Patent Application Publication
(10) Pub. No.: US 2024/0289934 A1
(43) Pub. Date: Aug. 29, 2024

(54) ERGONOMIC EVALUATION METHOD AND SIMULATION SYSTEM BASED ON VIRTUAL-REAL FUSION

(71) Applicant: NANJING UNIVERSITY OF POSTS AND TELECOMMUNICATIONS, Jiangsu (CN)

(72) Inventors: Haigen YANG, Jiangsu (CN); Qianqian HUANG, Jiangsu (CN); Mei WANG, Anhui (CN); Luyang LI, Anhui (CN); Erhan DAI, Jiangsu (CN)

(73) Assignee: NANJING UNIVERSITY OF POSTS AND TELECOMMUNICATIONS, Jiangsu (CN)

(21) Appl. No.: 18/602,010

(22) Filed: Mar. 11, 2024

Related U.S. Application Data
(63) Continuation of application No. PCT/CN23/86121, filed on Apr. 4, 2023.

(30) Foreign Application Priority Data
Feb. 27, 2023 (CN) 202310171448.9

(51) Int. Cl. G06T 7/00; G06F 3/01; G06T 7/246; G06T 7/73; G06T 11/00

(52) U.S. Cl. CPC G06T 7/0002; G06F 3/011; G06T 7/246; G06T 7/73; G06T 11/00; G06T 2207/30196

(57) ABSTRACT

Disclosed are an ergonomic evaluation method and simulation system based on virtual-real fusion. The system includes a user and device module, a virtual scene building module, and a data processing and analysis module. The method includes: obtaining real-time human joint point position data by means of a human motion capturing device, generating a character model of a current posture, and integrating the character model into a visual device and a personal computer (PC) terminal that are implanted with a virtual scene; obtaining comprehensive human joint point data through computation according to the real-time human joint point position data, and obtaining virtual scene data; and determining a human motion according to the comprehensive human joint point data and the virtual scene data, obtaining human posture data, obtaining human posture evaluation information through computation, and conducting analysis to determine whether an ergonomic evaluation index is rational.

### CROSS-REFERENCE TO RELATED APPLICATION

This application is a continuation of international application of PCT application serial no. PCT/CN2023/086121, filed on Apr. 4, 2023, which claims the priority benefit of China application no. 202310171448.9, filed on Feb. 27, 2023. The entirety of each of the above mentioned patent applications is hereby incorporated by reference herein and made a part of this specification.

### TECHNICAL FIELD

The present disclosure relates to an ergonomic evaluation method and simulation system based on virtual-real fusion, and belongs to the technical field of ergonomic evaluation of human factors engineering.

### RELATED ART

Traditional assembly analysis is mainly implemented through observation and analysis on a worker in an actual assembly process. For analysis on man-machine factors such as visibility, accessibility, comfort, fatigue and safety of an assembly worker, physical prototypes need to be produced for experiments, which takes a lot of material resources, manpower and time. In this case, an assembly process design seriously lags behind product design work, and consumes much longer time compared with a concurrent design. Moreover, defects in a product assembly design cannot be found and overcome in time, and safety and comfort of the worker cannot be ensured. Limited by physical prototypes, this traditional assembly analysis method has many disadvantages. Therefore, it is necessary to use new technical methods to satisfy requirements of concurrent design of products, such that designers can conduct assembly design and verification at a product design stage.

With continuous development of the computer technology and the virtual reality technology, simulating assembly work in a virtual environment has become an important design and analysis means. Virtual assembly simulation of “assembling a virtual person with a virtual product” can be completely achieved by introducing a digital prototype and a human model of a product into the virtual environment and formulating an assembly process according to product features. In addition, assembly process analysis and ergonomic analysis can be conducted on the basis of assembly simulation, such that problems of a product design can be found and modified in time. In this way, the concurrent design of the product is achieved, and an actual product assembly process is assisted. However, the prior art has a problem of inaccurate ergonomic analysis in virtual assembly simulation, and problems in a product design or assembly process cannot be found and modified in time.

### SUMMARY OF INVENTION

An objective of the present disclosure is to overcome defects in the prior art and provide an ergonomic evaluation method and simulation system based on virtual-real fusion, such that a problem of inaccurate ergonomic analysis in virtual assembly and simulation in the prior art is solved, and ergonomic analysis in an immersive assembly process of a worker is achieved. In this way, problems existing in product design or assembly processes are discovered and modified in time, concurrent designing of products is achieved, and an actual product assembly process is assisted.

In order to achieve the objective, the present disclosure is implemented through the following technical solution:

In a first aspect, the present disclosure provides an ergonomic evaluation method based on virtual-real fusion. The method includes:
obtaining real human joint point position data by means of a human motion capturing device, generating a character model of a current posture, and integrating the character model into a visual device and a personal computer (PC) terminal that are implanted with a virtual scene;
obtaining comprehensive human joint point data through computation according to the received human joint point position data, and obtaining virtual scene data; and
determining a human motion according to the comprehensive human joint point data and the virtual scene data, obtaining human posture data, obtaining human posture evaluation information through computation, and conducting analysis to determine whether an ergonomic evaluation index is rational.

Further, the obtaining the human joint point position data of a real person by means of the human motion capturing device, generating the character model of a current posture, and integrating the character model into the visual device and the PC terminal that are implanted with the virtual scene include:
configuring interfaces related to the human motion capturing device and the visual device implanted with the virtual scene, and connecting the human motion capturing device to the virtual scene;
enabling a person to do a corresponding motion by wearing the human motion capturing device and the visual device, and generating the real-time human joint point position data by means of the human motion capturing device;
obtaining the real-time human joint point position data, and generating the character model of the current posture; and
synchronizing the character model of the current posture to the virtual character model in the virtual scene on the PC terminal.

Further, the configured interfaces related to the human motion capturing device and the visual device implanted with the virtual scene may be a transmission mode interface, a device time synchronization interface, or a communication protocol interface, and the motion capturing device and the virtual scene may be connected by calling various interfaces.

Further, the obtained real-time human joint point position data includes position data of joint points of fingers, palms, forearms, back arms, shoulders, toes, soles, calves, thighs and hips in limbs, joint points of a head, a neck, and lumbar vertebrae L1-L5, etc. that may describe a human posture.

Further, a method for implanting the visual device and the PC terminal with the virtual scene includes:
determining a working scene, and designing a product model related to a work and a virtual scene corresponding to the work, where for instance, in assembly work, an assembly scene is determined, a product model to be assembled is designed, and a corresponding virtual assembly scene is designed;
setting a physical property of the product model, where for instance, physical properties are set for the product model assembled in the virtual scene, and the physical properties include a mass, a length, a width, a height, a center of mass, a position in the scene, etc.; and
implanting the virtual scene, the product model and the physical property of the product model that are designed above into the related visual device and the PC terminal configured to analyze data in a form of software.

Further, the obtaining comprehensive human joint point data through computation according to the real-time human joint point position data, and obtaining virtual scene data include:
obtaining data such as angles, heights and relative positions between all human joints through computation according to the real-time human joint point position data; and
importing the virtual scene seen by a real person in the visual device into the PC terminal in real time, such that a virtual character linked during operation is synchronized with the virtual scene.

Further, the determining the human motion according to the comprehensive human joint point data and the virtual scene data, obtaining the human posture data, obtaining the human posture evaluation information through computation, and conducting analysis to determine whether the ergonomic evaluation index is rational include:
determining a type of the motion done by a human body according to changes between the comprehensive human joint point data and the virtual scene data, such as lifting and placing, pushing and pulling, or carrying, and obtaining the human posture data;
introducing the human posture data into various ergonomic evaluation algorithms, and obtaining the human posture evaluation information; and
obtaining a determination result of whether the ergonomic evaluation index is rational according to the human posture evaluation information in combination with a result analysis standard of each of the ergonomic evaluation algorithms.

Further, the ergonomic evaluation algorithm may be RULA, NOISH 1991, or Snook & Ciriello 1991.

Further, the ergonomic evaluation indexes include an operation sequence, a method, a posture, a workload, etc.

A human posture evaluation result may be obtained in real time according to the human posture evaluation information, which guides an assembly process in real time. Corresponding humanized improvement and optimization are conducted on product designs while safety and comfort of the human body are ensured, and further working efficiency in future production line assembly is improved.

In a second aspect, the present disclosure provides an ergonomic evaluation simulation system based on virtual-real fusion. The system is configured to implement the ergonomic evaluation method based on virtual-real fusion according the first aspect and includes a user and device module, a virtual scene building module, and a data processing and analysis module. The three modules are connected to and interact with each other through a virtual reality engine.

Further, the user and device module includes the human motion capturing device, and the visual device. The visual device is preferably a head-mounted visual device. The head-mounted visual device is preferably virtual reality (VR) glasses.

Further, the virtual scene building module is configured to build a complex device model, a virtual working environment, an assembly tool design, an assembly process design, an assembly operation design, and physical properties of the configured device. A designed scene model may be reused, such that a general model and scene designed in advance may be stored in a model database, and may be directly called from the model database when building and designing the virtual scene. After the virtual scene is designed, the virtual scene is connected to the visual device by means of a control unit, such that virtual-real fusion is achieved.

Further, the data processing and analysis module is configured to conduct data processing and analysis, which includes visual field analysis, accessible domain analysis, Rula posture evaluation analysis, NOISH lifting analysis, Snook & Ciriello table analysis, and operation design suggestion analysis.

Compared with the prior art, the present disclosure has the beneficial effects:

The present disclosure implements an ergonomic evaluation method in an interaction process between the real person and the virtual scene. Through the method, a researcher may experience various tasks in the virtual scene in an immersive manner, and further verify whether the operation sequence, the method, the posture, the workload, etc. in the assembly process are rational. Virtual-real fusion is implemented, such that the real people may interact with the virtual scene, and defects of traditional immersive verification are overcome.

According to the present disclosure, the real-time position data of each joint point of the human body generated by the motion capturing device is synchronized with a motion simulation process of the character model in the virtual scene, such that accuracy of the human motion can be truly reflected, and the method is suitable for various complex assembly processes. Meanwhile, a safety problem in traditional immersive experience is avoided, and accuracy of man-machine evaluation is ensured.

According to the present disclosure, the angles and position relations between all the joints are analyzed in combination with the human joint point position data, and man-machine evaluation results under various postures are computed with reference to various man-machine evaluation standards. Further, rationality of the operation sequence, the method, the posture and the workload is analyzed in the assembly process, and corresponding improvement suggestions are given.

The method of the present disclosure can quickly build complex assembly simulation, verify the assembly sequence and posture, and ensure accuracy of ergonomic evaluation. The model building under the method may be modularized and classified, and may be reused, which saves cost and improves a verification rate.

The method of the present disclosure is not limited to a simulation environment of virtuality and reality combination of a real person-virtual scene or a real machine-a virtual scene.

### BRIEF DESCRIPTION OF DRAWINGS

FIG. 1 is a flow diagram of an ergonomic evaluation method based on virtual-real fusion according to Example 1 of the present disclosure.

FIG. 2 is a schematic application diagram of an ergonomic evaluation method based on virtual-real fusion according to an example.

FIG. 3 is a schematic structural diagram of an ergonomic evaluation simulation system based on virtual-real fusion according to Example 2.

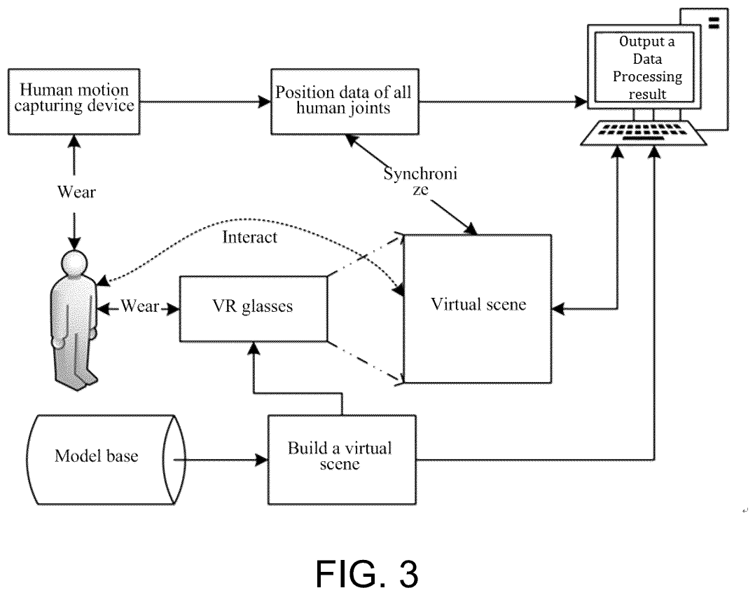

### DESCRIPTION OF EMBODIMENTS

Technical solutions of the present disclosure will be described in detail below with reference to accompanying drawings and specific examples. It should be understood that the examples of the present disclosure and specific features in the examples describe the technical solutions of the present disclosure in detail, instead of limiting the technical solutions of the present disclosure. The examples of the present disclosure and technical features in the examples can be combined with each other without conflict.

### Example 1

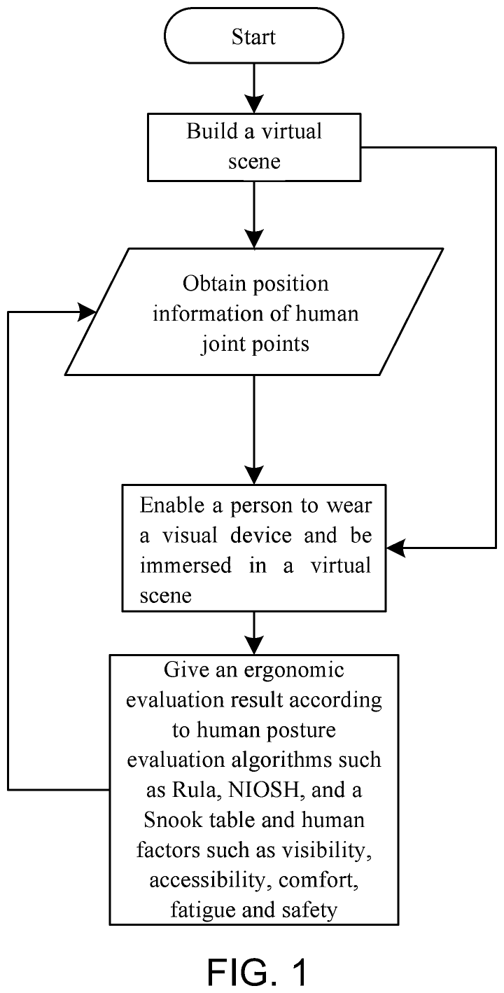

FIG. 1 is a flow diagram of an ergonomic evaluation method based on virtual-real fusion according to the example. The flow diagram only shows a logical order of the method according to the example. The steps shown or described may be completed in a different order from that shown in FIG. 1 in other possible examples of the present disclosure on the premise of not conflicting with each other.

The ergonomic evaluation method based on virtual-real fusion according to the example is applied to assembly work. With reference to FIG. 1, the method of the example specifically includes the following steps:
S1, a virtual scene is built, and the virtual scene is implanted into a related head-mounted visual device and a personal computer (PC) terminal.
S2, a human motion capturing device is worn, real human joint point position data is obtained, and a character model of a current posture is generated.
S3, the human joint point position data is received and integrated into the visual device and the PC terminal.
S4, comprehensive human joint point data is obtained through computation according to the received human joint point position data, and virtual scene data is obtained.
S5, a human motion is determined in combination with the human joint point data and the virtual scene data, human posture data is obtained, and human posture evaluation information is obtained through computation.
S6, whether an ergonomic evaluation index in an assembly process is rational is determined according to the human posture evaluation information in combination with a result analysis standard of each evaluation algorithm, and a related suggestion is given.
In S1, a process that the virtual scene is built, and the virtual scene is implanted into the related visual device and the PC terminal includes the following steps:
S11, an assembly scene is determined, a product model to be assembled is designed, and a corresponding virtual assembly scene is designed.
S12, physical properties are set for a product model assembled in a virtual assembly scene, and the physical properties include a mass, a length, a width, a height, a center of mass, a position in the scene, etc.
S13, the virtual scene, the product model and the physical property of the product model that are designed are implanted into the related visual device and the PC terminal configured to analyze data in a form of software.

In the example, a method for obtaining position data of all human joints is implemented in a wearable mode.
In S2, a process that the human motion capturing device is worn, the real human joint point position data is obtained, and the character model of the current posture is generated includes the following steps:
S21, interfaces related to the human motion capturing device and the visual device implanted with the virtual scene are configured, and the human motion capturing device is connected to the virtual scene.
S22, a person does a corresponding assembly motion by wearing the human motion capturing device and the head-mounted visual device, and the real-time human joint point position data is generated by means of the motion capturing device.
S23, the real-time human joint point position data is obtained, which includes position data of joint points of fingers, palms, forearms, back arms, shoulders, toes, soles, calves, thighs and hips in limbs, joint points of a head, a neck, and lumbar vertebrae L1-L5, etc. that may describe a human posture; the character model of the current posture is generated; and the obtained real-time data is converted into a binary format facilitating transmission, so as to be stored.

In S3, a process that the human joint point position data is received and integrated into the visual device and the PC terminal is specifically as follows:

A real person conducts various complex assembly tasks by wearing virtual reality (VR) glasses implanted with the virtual scene, and meanwhile, operations in the virtual scene and the position data of all the human joints collected by the human motion capturing device are synchronized to the PC terminal for later data processing.

In S4, a process that the comprehensive human joint point data is obtained through computation according to the received human joint point position data, and the virtual scene data is obtained is specifically as follows:

The comprehensive human joint point data such as angles, heights and relative positions between all the human joints is obtained through computation according to the received human joint point position data; and the virtual scene seen by a real person in the visual device is imported into the PC terminal in real time, such that a virtual character linked during operation is synchronized with the virtual scene.

In S5, a process that the human motion is determined in combination with the human joint point data and the virtual scene data, the human posture data is obtained, and the human posture evaluation information is obtained through computation is specifically as follows:

A type of the motion done by a human body is determined according to changes between the comprehensive human joint point data and the virtual scene data, such as lifting and placing, pushing and pulling, or carrying, and the human posture data is obtained. The human posture data is introduced into various ergonomic evaluation algorithms, such as RULA, NOISH 1991, or Snook & Ciriello 1991, and a human posture evaluation result in an immersive assembly task of a person is obtained through computation.

In S6, a process that whether the ergonomic evaluation index in the assembly process is rational is determined according to the human posture evaluation information in combination with the result analysis standard of each evaluation algorithm, and the related suggestion is given is specifically as follows:

A determination result of whether an operation sequence, a method, a posture, a workload, etc. in the assembly process are rational is obtained according to the human posture evaluation information in combination with the result analysis standard of each evaluation algorithm, and the related suggestion is given. A human posture evaluation result is obtained in real time according to the human posture evaluation information, which guides the assembly process in real time. Corresponding humanized improvement and optimization are conducted on product designs while safety and comfort of the human body are ensured, and further working efficiency in future production line assembly is improved.

Through the Rula posture evaluation algorithm, a score of a current human posture is evaluated on the basis of the angles and the position relations between all the human joints in combination with physical properties of assembled objects. Further, whether a posture of a user in the assembly process is rational and whether an assembly posture has to be changed to minimize damage caused to a person in an assembly operation process are determined through analysis.

Through the NOISH 1991 evaluation algorithm, a maximum acceptable weight of an object lifted/placed when the person lifts/places the object in the assembly process is analyzed. On the basis of information such as a height, a distance, a coupling degree with hands, a frequency, a torsion degree of the object lifted/placed, the maximum acceptable weight may be computed according to an NOISH 1991 formula. Further, a design with the least damage to the worker may be satisfied in an actual assembly design process, and accurate ergonomic evaluation is achieved.

Through a Snook & Ciriello table, various motions, such as lifting and placing, pushing and pulling, and carrying, may be analyzed. The method is based on data of a Snook & Ciriello 1991 table. Under different motions and genders, a man-machine evaluation result of the maximum acceptable weight is obtained through linear interpolation, and further applied to ergonomic result analysis. Lifting and placing analysis in the method may be combined with results of NOISH lifting and placing analysis, with results of NOISH mainly used and results of the maximum acceptable weight in the method supplemented, such that more suitable parts or tools for product assembly are designed. The man-machine evaluation result of the maximum acceptable weight in the method are further related to gender. Different assembled products may be designed for workers of specific genders. In this way, efficiency of product assembly is improved, and damage to the worker in the assembly process is reduced.

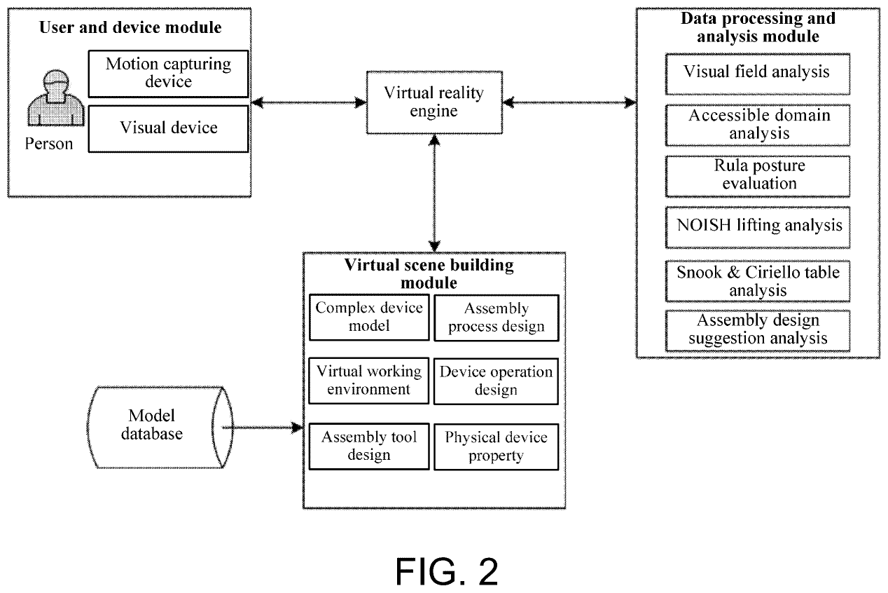

An entire set of assembly process is dynamically simulated for a user for assembly ergonomic verification. As shown in FIG. 2, through real-time result analysis, the present disclosure finally provides an ergonomic analysis result of each demonstration stage after demonstrating the entire set of assembly process, and gives a specific modification suggestion, for instance, a design posture of a certain demonstration stage needs to be adjusted, or assembled parts need to be adjusted.

### Example 2

FIG. 2 shows an ergonomic evaluation simulation system based on virtual-real fusion according to the example. The system is configured to implement the ergonomic evaluation method based on virtual-real fusion according to Example 1 and includes a user and device module, a virtual scene building module, and a data processing and analysis module. The three modules are connected to and interact with each other through a virtual reality engine. In practical application, the virtual reality engine may be virtual reality fusion software of a PC terminal.

The user and device module includes a user for assembly ergonomic verification, a human motion capturing device, and a visual device.

The human motion capturing device is configured to record an actual motion trajectory and human posture information of the user for ergonomic assembly in a simulated assembly process, so as to obtain motion trajectory data and human posture information data in a real environment, that is, dynamic position data of all human joints. According to data obtained by the human motion capturing device, a virtual human model is drawn, such that real-time synchronized virtual human model data is obtained. The human motion capturing device collects and transmits real-time human posture data to a control unit of the virtual reality engine for virtual-real fusion.

The visual device is a head-mounted visual device, and specifically VR glasses of virtual reality. A built virtual scene having an interactive function is introduced into the VR glasses. A person wears the visual device and completes a process of complex assembly operations in the virtual scene in an immersive manner. In the process, the visual device may further synchronize real-time interactive data to the control unit of the virtual reality engine for virtual-real fusion.

The virtual scene building module is configured to build a complex device model, a virtual working environment, an assembly tool design, an assembly process design, an assembly operation design, and physical properties of the configured device. A designed scene model may be reused, such that a general model and scene designed in advance may be stored in a model database, and may be directly called from the model database when building and designing the virtual scene. After the virtual scene is designed, the virtual scene is connected to the visual device by means of the control unit of the virtual reality engine, such that virtual-real fusion is achieved.

The data processing and analysis module is configured to conduct data processing and analysis, which includes visual field analysis, accessible domain analysis, Rula posture evaluation analysis, NOISH lifting analysis, Snook & Ciriello table analysis, and operation design suggestion analysis.

The visual field analysis is configured to determine whether a design of assembly steps or other operations within the visual range is rational in a process of wearing the visual device by the user for assembly ergonomic verification, in an assembly scene seen in the visual device and a visually accessible range in the assembly process. A window may be opened alone in the control unit so as to specially display a visual range of the user in an operation process in the visual device.

The accessible domain analysis is configured to indicate whether it is convenient and rational to obtain surrounding tools or parts in the assembly process and during engagement in an activity in a range accessible by the user in an assembly operation process of the virtual scene.

In Rula posture evaluation, through the Rula posture evaluation algorithm, a score of a current human posture is evaluated on the basis of the angles and the position relations between all the human joints in combination with physical properties of assembled objects. Further, whether a posture of a user in the assembly process is rational and whether an assembly posture has to be changed to minimize damage caused to a person in an assembly operation process are determined through analysis.

The NOISH lifting analysis is mainly to analyze a maximum acceptable weight of an object lifted/placed when the person lifts/places the object in the assembly process. On the basis of information such as a height, a distance, a coupling degree with hands, a frequency, a torsion degree of the object lifted/placed, the maximum acceptable weight may be computed according to an NOISH 1991 formula. Further, a design with the least damage to the worker may be satisfied in an actual assembly design process, and accurate ergonomic evaluation is achieved.

The Snook & Ciriello table analysis is suitable for analyzing various motions, such as lifting and placing, pushing and pulling, and carrying. The method is based on data of a Snook & Ciriello 1991 table. Under different motions and genders, a man-machine evaluation result of the maximum acceptable weight is obtained through linear interpolation, and further applied to ergonomic result analysis. Lifting and placing analysis in the method may be combined with results of NOISH lifting and placing analysis, with results of NOISH mainly used and results of the maximum acceptable weight in the method supplemented, such that more suitable parts or tools for product assembly are designed. The man-machine evaluation result of the maximum acceptable weight in the method are further related to gender. Different assembled products may be designed for workers of specific genders. In this way, efficiency of product assembly is improved, and damage to the worker in the assembly process is reduced.

In assembly design suggestion analysis, an entire set of assembly process is dynamically simulated for a user for assembly ergonomic verification. Through real-time result analysis, the present disclosure finally provides an ergonomic analysis result of each demonstration stage after demonstrating the entire set of assembly process, and gives a specific modification suggestion, for instance, a design posture of a certain demonstration stage needs to be adjusted, or assembled parts need to be adjusted.

Through an ergonomic evaluation technology of virtual-real fusion, defects of traditional immersive ergonomic evaluation, such as slow timeliness, long cycle and high cost can be effectively overcome, such that the user may design products that satisfy ergonomics quickly before formal production of product design, and cost of production design is reduced. Meanwhile, a set of worker-friendly assembly procedures and working methods may be designed, such that assembly efficiency is greatly improved, damage to workers in assembly is reduced, work enthusiasm and efficiency of workers are improved, and competitiveness of enterprises is enhanced.

Those skilled in the art should understand that the examples of the present disclosure can be provided as methods, systems, or computer program products. Therefore, the present disclosure can employ full hardware examples, full software examples, or software and hardware combined examples. Moreover, the present disclosure can take a form of a computer program product implemented on one or more computer usable storage media (including, but not limited to, a disk memory, a compact disc read-only memory (CD-ROM), an optical memory, etc.) including computer usable program codes.

The present disclosure is described with reference to flow diagrams and/or block diagrams of methods, devices (systems), and computer program products according to the examples of the present disclosure. It should be understood that each flow and/or block in the flow diagrams and/or block diagrams and combinations of the flows and/or blocks in the flow diagrams and/or block diagrams can be implemented by computer program instructions. The computer program instructions can be provided for a processor of a general-purpose computer, a special-purpose computer, an embedded processor, or other programmable data processing devices, to produce a machine, such that instructions executed by the processor of the computer or other programmable data processing devices produce an apparatus used for implementing functions specified in one or more flows of each flow diagram and/or one or more blocks of each block diagram.

The computer program instructions can also be stored in a computer-readable memory that is capable of guiding a computer or other programmable data processing devices to work in a specific manner, such that the instructions stored in the computer-readable memory produce an article of manufacture including an instruction apparatus, and the instruction apparatus implements functions specified in one or more flows of each flow diagram and/or one or more blocks in each block diagram.

The computer program instructions can be loaded onto a computer or another programmable data processing device, such that a series of operations and steps are conducted on the computer or the another programmable device, thereby generating computer-implemented processing. Therefore, the instructions executed on the computer or the another programmable device provide steps for implementing a specific function in one or more flows in the flow diagrams and/or in one or more blocks in the block diagrams.

What are described above are merely the preferred embodiments of the present disclosure. It should be noted that those of ordinary skill in the art can also make some improvements and transformations without departing from the technical principle of the present disclosure, and these improvements and transformations should also fall within the protection scope of the present disclosure.

What is claimed is:

1. An ergonomic evaluation method based on virtual-real fusion, comprising:
obtaining real-time human joint point position data by means of a human motion capturing device, generating a character model of a current posture, and integrating the character model into a visual device and a personal computer terminal that are implanted with a virtual scene;
obtaining comprehensive human joint point data through computation according to the real-time human joint point position data, and obtaining virtual scene data; and
determining a human motion according to the comprehensive human joint point data and the virtual scene data, obtaining human posture data, obtaining human posture evaluation information through computation, and conducting analysis to determine whether an ergonomic evaluation index is rational.

2. The ergonomic evaluation method based on virtual-real fusion according to claim 1, wherein step of obtaining the real-time human joint point position data of a real person by means of the human motion capturing device, generating the character model of the current posture, and integrating the character model into the visual device and the personal computer terminal that are implanted with the virtual scene comprise:
configuring interfaces related to the human motion capturing device and the visual device implanted with the virtual scene, and connecting the human motion capturing device to the virtual scene;
enabling a person to do a corresponding motion by wearing the human motion capturing device and the visual device, and generating the real-time human joint point position data by means of the human motion capturing device;
obtaining the real-time human joint point position data, and generating the character model of the current posture; and
synchronizing the character model of the current posture to a virtual character model in the virtual scene on the personal computer terminal.

3. The ergonomic evaluation method based on virtual-real fusion according to claim 2, wherein the obtained real-time human joint point position data is position data of joint points that can describe a human posture, and the joint points comprise joint points of fingers, palms, forearms, back arms, shoulders, toes, soles, calves, thighs and hips in limbs, and joint points of a head, a neck, and lumbar vertebrae L1-L5.

4. The ergonomic evaluation method based on virtual-real fusion according to claim 2, wherein a method for implanting the visual device and the personal computer terminal with the virtual scene comprises:
determining a working scene, and designing a product model related to a work and a virtual scene corresponding to the work;
setting a physical property of the product model; and
implanting the virtual scene, the product model and the physical property of the product model that are designed above into the visual device and the personal computer terminal configured to analyze data in a form of software.

5. The ergonomic evaluation method based on virtual-real fusion according to claim 1, wherein step of obtaining the comprehensive human joint point data through computation according to the real-time human joint point position data, and obtaining the virtual scene data comprise:
obtaining data including angles, heights and relative positions between all human joints through computation according to the real-time human joint point position data; and
importing the virtual scene seen by a real person in the visual device into the personal computer terminal in real time, such that a virtual character linked during operation is synchronized with the virtual scene.

6. The ergonomic evaluation method based on virtual-real fusion according to claim 1, wherein step of determining the human motion according to the comprehensive human joint point data and the virtual scene data, obtaining the human posture data, obtaining the human posture evaluation information through computation, and conducting analysis to determine whether the ergonomic evaluation index is rational comprise:
determining a type of the motion done by a human body according to changes between the comprehensive human joint point data and the virtual scene data, and obtaining the human posture data;
introducing the human posture data into various ergonomic evaluation algorithms, and obtaining the human posture evaluation information; and
obtaining a determination result of whether the ergonomic evaluation index is rational according to the human posture evaluation information in combination with a result analysis standard of each of the ergonomic evaluation algorithms.

7. The ergonomic evaluation method based on virtual-real fusion according to claim 6, wherein the ergonomic evaluation algorithms comprise RULA, NOISH 1991, or Snook & Ciriello 1991.

8. An ergonomic evaluation simulation system based on virtual-real fusion, being configured to implement the ergonomic evaluation method based on virtual-real fusion according to claim 1 and comprising a user and device module, a virtual scene building module, and a data processing and analysis module, wherein the three modules are connected to and interact with each other through a virtual reality engine.

9. The ergonomic evaluation simulation system based on virtual-real fusion according to claim 8, wherein the user and device module comprises the human motion capturing device and the visual device.

10. The ergonomic evaluation simulation system based on virtual-real fusion according to claim 8, wherein the data processing and analysis module is configured to conduct data processing and analysis, which comprises visual field analysis, accessible domain analysis, Rula posture evaluation analysis, NOISH lifting analysis, Snook & Ciriello table analysis, and operation design suggestion analysis.
